(19) United States
(12) Patent Application Publication
(10) Pub. No.: US 2009/0228501 A1
(43) Pub. Date: Sep. 10, 2009

(54) JOINT RESPONSE INCIDENT MANAGEMENT SYSTEM

(76) Inventors: JOHN J. SHOCKRO, North Attleboro, MA (US); Yolanda L. McClease, Tyngsboro, MA (US); George W. Spencer, JR., Westborough, MA (US)

Correspondence Address: RAYTHEON COMPANY;C/O DALY, CROWLEY, MOFFORD & DURKEE, LLP, 354A TURNPIKE STREET, SUITE 301A, CANTON, MA, 02021, US

(21) Appl. No.: 12/399,166

(22) Filed: Mar. 6, 2009

Related U.S. Application Data
(60) Provisional application No. 61/034,330, filed on Mar. 6, 2008.

(51) Int. Cl. G06F 17/30

(52) U.S. Cl. 707/100; 707/E17.048

(57) ABSTRACT

An incident management system includes a plurality of information sources, each of the information sources configured to collect information for use by a plurality of joint-responders in an incident management process, an information integrator configured to receive and store information from each of the information sources, and at least one semantic model coupled to the information integrator, the semantic model including a plurality of relationships associated with the plurality of joint-responders. The system further includes an application logic processor which utilizes the at least one semantic model to determine which of a plurality of joint-responder organizations should receive information from the information integrator, and a registry processor coupled to the information integrator to help at least some of the plurality of joint-responders connect to desired information within at least a portion of the plurality of information sources.

### RELATED APPLICATIONS

This application claims the benefit of U.S. Provisional Application No. 61/034,330 filed Mar. 6, 2008 under 35 U.S.C. §119(e) which application is hereby incorporated herein by reference in its entirety.

### FIELD OF THE INVENTION

This invention relates to an approach for integrating disparate sources of information for the purpose of supporting border security and emergency response operations.

### BACKGROUND

As is known in the art, organizations responsible for border security and emergency response continually plan and train to react to possible events so they can take actions to prevent the event or rapidly mitigate its effects. The nature of the world is, however, that unforeseen things happen, sometimes at a scale that warrants a collaborative response over many days from numerous organizations at the local, regional, and national levels.

Such large scale, unforeseen events and responses to the events generally have at least some common attributes. For example, at the start of these events, the true nature of the situation may be unclear. Also, the success of a response is directly related to how quickly decision makers can understand the nature of the event. Furthermore, many government organizations, non-governmental organizations, and even the general public are involved in these events and the situation is often very dynamic as different organizations and different personnel continuously arrive at the scene. Further still, each organization involved in the response needs to join in the response conversation. Also, each organization may bring with them information systems that would be helpful to high level decision makers. Unfortunately, these systems are often designed to support only the owning organization.

Furthermore, valuable information may be created at the scene of an event by news organizations and the general public's telephone calls (e.g., telephone calls) and cell phone photos. The on-scene, local resources need to connect to coordination layers at the regional and national levels to be effective. Yet the on-scene organizations often do not have the broad perspective required to allocate resources and the higher, coordinating levels don't have site-specific details.

Getting the right information to the right people/organizations, at the right time is clearly an answer for this problem. The problem remains of how to accomplish such a feat when large numbers of organizations and large numbers of information sources are involved. Large-scale incidents typically require a collaborative response over many days from numerous local, state, and national organizations that haven't planned and trained together. These organizations may have different information systems, may use different terminology, and may have unique approaches to solving problems. Effective response and mitigation requires efficient sharing and distribution of information by everyone in response and/or mitigation efforts.

The diverse information systems involved in such a response are often developed to support narrow functions and specific organizational needs, not large scale information sharing and distribution. Information sources from these legacy systems need to be integrated. Also, effective joint response solution must accommodate large, changing sets of users, organizations, and information sources. Conventional systems that provide support in ordinary situations fail to provide appropriate levels of support when an incident affects large areas and large numbers of people. Further, some participants may get too much information that is not needed, while essential information that could improve effectiveness does not reach these participants. To complicate the problem, people/organizations are often confused about jurisdiction and responsibilities.

### SUMMARY

It is impossible to know beforehand all the information systems that might be available and required to effectively respond in all situations. Thus, the systems and techniques described herein facilitate the adding of new information whether from existing systems, or from involved parties (e.g. first responders) located at the scene of an event. The system and techniques described herein also facilitate users obtaining information which is desirable, necessary, and essential to a decision making or strategy forming process from all the available information resources that are connected to this environment.

Communication problems can best be solved by facilitating the transfer of information between people and organizations. A useful metaphor for approaches described herein is that of a switchboard staffed by an expert operator. In that frame of reference, communication lines are attached to the switchboard in a standard way. An expert operator helps people connect with the right communication line. Information sources may be attached to a software-based switchboard using web services standards. Semantic models and a registry help people and organizations connect (e.g., gain access) to the desirable, necessary, and essential information.

The systems and techniques for data integration and communication described herein rely on a loosely-coupled computer architecture including components with standards-based interfaces. The systems and techniques described herein facilitate getting information from the many other systems that might be needed to mitigate an adverse outcome to an incident. The standards-based interfaces facilitate the use of the services described herein by other systems. This “openness” facilitates the flow of information from an incident site to decision makers and facilitators at higher coordination levels and down from these higher coordination levels to people on the scene. These decision makers and facilitators include involved parties and, in particular, may include joint-responders to an incident. Joint-responders include, but are not limited to, first responders at the scene of an event, as well as administrators and support personnel within involved organizations.

Semantic models include terms and relationships that are relevant to the tasks users have to perform in the response environment to help them get information that is desirable, necessary, and essential. This knowledgeable guidance helps users be more precise in formulating their information needs, and will, therefore, reduce unwanted information, and increase the likelihood of getting the right information at the right time.

In one aspect, an incident management system includes a plurality of information sources, each of the information sources configured to collect information for use by a plurality of joint-responders in an incident management process, an information integrator configured to receive and store information from each of the information sources, at least one semantic model coupled to the information integrator, the semantic model including a plurality of relationships associated with the plurality of joint-responders, an application logic processor which utilizes the at least one semantic model to determine which of a plurality of joint-responder organizations should receive information from the information integrator, and a registry processor coupled to the information integrator to help at least some of the plurality of joint-responders connect to desired information within at least a portion of the plurality of information sources.

Further embodiments of the incident management system may include one or more of the following features; the incident management process is associated with at least one of border security and emergency response; and comprising a portlet coupled to the application logic processor through the semantic model, the portlet having controls for users to select data sources, select query parameters, and enter query information.

In another aspect, a method of incident management includes collecting information for a plurality of information sources for use by a plurality of joint-responders, in an information integrator, receiving and storing information from each of the plurality of information sources, coupling at least one semantic model to the information integrator, the at least one semantic model including a plurality of relationships associated with the plurality of joint-responders. The method further includes, in an application logic processor, utilizing the at least one semantic model to determine which of a plurality of joint-responder organizations should receive information, and using a registry processor coupled to the information integrator to connect at least some of the plurality of joint-responders to desired information within at least a portion of the plurality of information sources

Further embodiments of the method may include one or more of the following features: the incident is associated with at least one of border security and emergency response; and providing a portlet coupled to the application logic processor through the semantic model, the portlet having controls for users to select data sources, select query parameters, and enter query information.

Joint responders can use the system and techniques to mitigate an adverse outcome to an incident. A variety of information sources are configured to collect important information, such as infrastructure data (e.g., floor plans, roads and bridges, power grids, etc.) and real-time data (e.g. video feeds, sensor data, and weather related information). This information is shared and distributed across various organizational structures which are represented and conceptualized in a semantic model.

The semantic model may be preconfigured based on known and understood organizational relationships. Such information may have been gathered from prior events involving organizational usages of the information sources and communications between and among organizations. Furthermore, the semantic model may be built and updated in real-time (e.g., as an event unfolds) based on tracking of information that is desired, needed, and/or essential by various joint-responders. For example, it may be that one or more joint-responders is interested in gun shot tracking data from a gun shot sensing system and may request such data from law enforcement information sources. The system can update the semantic model to create a relationship between the joint-responders and the law enforcement organization as well as the desired gun shot sensing data. As the gun shot sensing data is received and updated, or with the confirmation of recent gun shot events, the system can distribute the information to the joint-responders. In this way, joint-responders can quickly and efficiently obtain information that is desired, necessary, and/or essential.

In a further aspect, an incident management system includes a model builder configured to build at least one semantic model including a plurality of relationships between involved organizations, each of the involved organizations associated with at least one of a plurality of involved parties, an information extractor configured to capture at least one communication sent by one of the involved parties and received by at least one other of the involved parties and to send communications information to the model builder, and an information integrator configured to distribute a subject communication from an involved party sender to at least one involved party receiver based upon the at least one semantic model.

In further embodiments, the system includes one or more of the following features: the communications information includes a communications topic, a communications sender, and at least one communications receiver and the communications information is used by the model builder to define at least one of the plurality of relationships between involved organizations; the semantic model may further include the plurality of involved parties.

In still another aspect, a method of incident management includes, in a model builder, building at least one semantic model comprising a plurality of relationships between involved organizations, each of the involved organizations associated with at least one of a plurality of involved parties, in an information extractor, capturing at least one communication sent by one of the involved parties and received by at least one other of the involved parties and sending the communications information to the model builder, and in an information integrator, distributing a subject communication from an involved party sender to at least one involved party receiver based upon the at least one semantic model.

In further embodiments of the method, the communications information includes a communications topic, a communications sender, and at least one communications receiver and further includes defining at least one of the plurality of relationships between involved organizations using the communications information. In still further embodiments, the communications information includes a communications time, sender location and organization, and receiver location and organization.

The systems and techniques can be used to build a semantic model for organizational relationships between involved parties who communicate with each other to mitigate adverse consequences of an incident, such as a border security breach, terrorist attack, natural disaster, etc. Such organizational relationships may be created manually or automatically by capturing communications between the involved parties and identifying communications topics, as well as the sender and receiver of the communications. Once the semantic model is conceptualized, instances of the semantic model are created using concrete information, such as organization x includes individual a, b, and c, prior communications related to resource X have been sent from organization x to organization y, etc. The concrete information may further include various pieces of information of particular interest to individuals. For example, individual a may be interested in resource 1 and individual b and c may be interested in resource 2.

The semantic model can be queried to generate communications related to various pieces of information. For example, a query can be used to determine which individuals and/or organizations have an interest in resource 1. Once discovered, further communications related to resource 1 (e.g., updates to the status of resource 1) can be generated and distributed to the interested individuals.

Follow on communications related to various pieces of information may be generated based upon the time of prior communications, as well as the sender's location and organization, and the receiver's location and organization. For example, a semantic model can be built to include relationships between public safety organizations, such as law enforcement, emergency response, public works, and hospitals. Prior communications related to various incidents are used to create instances of the semantic model, such as the content of communications between and among these organizations, time sent, involved parties, organizations and locations.

Once the semantic model is built, further communications may then be distributed to involved parties and involved organizations based upon the stored organization structure of the semantic model as well as past content of communications. For example, a semantic model can collect and/or store organizational relationships between the on-scene officers and the local firehouses involved in a building fire at 123 Main Street. Prior communications may have established that these involved parties discuss certain resources, such as fire engines, as well as medical staff for treating the injured. A subject message from an on-scene officer requesting more support may be automatically sent to the local fire houses referenced in the semantic model. The location of the incident as well as the time of the incident may be compared to the stored model instances to filter out information that is not relevant. For example, a firehouse that is too far from the location of the incident will not receive the communications.

### BRIEF DESCRIPTION OF THE DRAWINGS

The foregoing features of this the inventive systems and methods may be more fully understood from the following description of the drawings in which:

FIG. 1 is a block diagram of an embodiment of an incident management system;

FIG. 2 is listing of an example XML schema of the type for use with the systems and techniques described herein;

FIG. 3 is a block diagram illustrating an information integrator for information sources;

FIG. 4 is a block diagram illustrating the extraction and use of information;

FIG. 5 is a pictorial representation of an ontology of the type for use with the systems and techniques described herein;

FIG. 6 is block diagram of message extraction;

FIG. 7 is a pictorial diagram of message flow to organizations and joint responders; and

FIG. 8 is a diagram showing an exemplary hardware and operating environment of a suitable computer for use with embodiments of the invention.

### DETAILED DESCRIPTION

In general overview, the systems and techniques described herein can be characterized as an interface to a knowledge-based query broker which receives information from multiple sources. The information may be provided as any type of data (e.g., binary data, database records, textual data, and image data) and is organized in semantic models representing data relationships and concepts (for example, organizational relationships, event-based relationships, etc.). The knowledge-based query broker is extendable to facilitate connecting to new information sources.

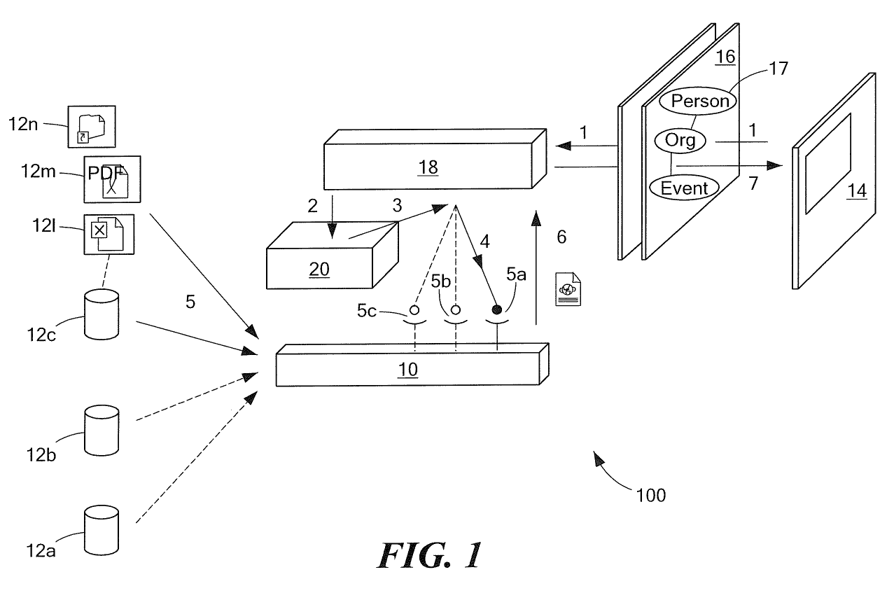

Referring now to FIG. 1, a system 100 for integrating disparate sources of information for the purpose of supporting event response operations (for example, operations involving border security, emergency response, commercial endeavors, etc.), military joint operators (for example, training exercises, command-and-control operations), or task forces includes an information integrator 10 having a plurality of disparate information sources 12a-12n coupled thereto (e.g., mapping information, organization information, event-driven data, law enforcement databases, motor vehicle registries, cameras, microphones, sensors, etc.). A semantic model 16 is coupled to the information integrator 10 through application logic processor 18. Semantic model 16 includes a plurality of relationships 17 associated with joint-responder organizations.

Furthermore, an application logic processor 18 uses the semantic model 16 to determine which joint-responder organizations should receive which information. A registry processor 20 is coupled to the information integrator 10 to help joint-responder organizations connect to desired information within the information sources 12a-12n. The system 100 may further include a portlet 14 coupled through the semantic model 16 to the application logic processor 18. In an embodiment, the portlet 14 has controls (e.g. software controls) for users to select data sources, select query parameters, and enter query information. The data sources and query information may be representative of the information sources 12a-12n.

In operation, as indicated by reference numeral 1 in FIG. 1, a user utilizes the portal 14 and semantic models 16 to select one, some, or all information sources 12a-12n and categories (for example, data about persons, data about hospitals, map layer data, etc.) that they wish to query. For example, the semantic model 16 may show organizational relationships 17 such as the reporting structures between multiple organizations. The application logic processor 18 uses the semantic models 16 to determine which information should be made available to which organizations. The application logic processor 18 also analyzes information flow and actual information being exchanged between different users of the system 100 (for example, by examining e-mail messages, instant messages a/k/a “IMs” or other information exchange technologies) and then makes a determination as to which persons/organization are exchanging information and the type or nature of the information being exchanged. The application logic processor 18 may use such information to enhance the semantic model 16. For example, the application logic processor 18 may extend relationships 17 and concepts of the semantic model 16, as well as add new relationships and concepts to the semantic model 16.

Advantageously, the application logic processor 18 can avoid information overload by making information available only to those users/organizations who desire to access the information (rather than making it available to every user/organization). As indicated by reference numerals 2, 3, the application logic processor 18 may obtain connection details from the service registry 20, which acts as a sort of “yellow pages” directory for the system 100. As indicated by reference numeral 4, the details provided by the service registry 20 are then used to connect to an appropriate service 5a, 5b, 5c that returns the desired query information. For example, the desired query information may be returned in an XML format (as indicated by reference numeral 6) that is compliant with community standards such as World Wide Web Consortium (W3C) standards. The information is then made available to the user, as indicated by reference numeral 7. Thus, the system 100 enables users to select information sources and categories they wish to query and to have such information returned to them in a preferred or standard format.

Each component of the above-described system is described in greater detail below.

In one embodiment, the information integrator 10 is a data services platform that provides National Information Exchange Model (NIEM) compliant extensible markup language (XML) documents. The NIEM is a set of XML schemas developed under the sponsorship of the Department of Justice and the Department of Homeland Security to facilitate sharing of information. The NIEM is predicated on identifying operational information exchanges among participating domains by examining current practices and documenting business requirements for information exchange between agencies and domains. NIEM also models new and innovative information exchange opportunities to achieve greater efficiency, effectiveness, return on investment (ROI), as well as new operational capabilities.

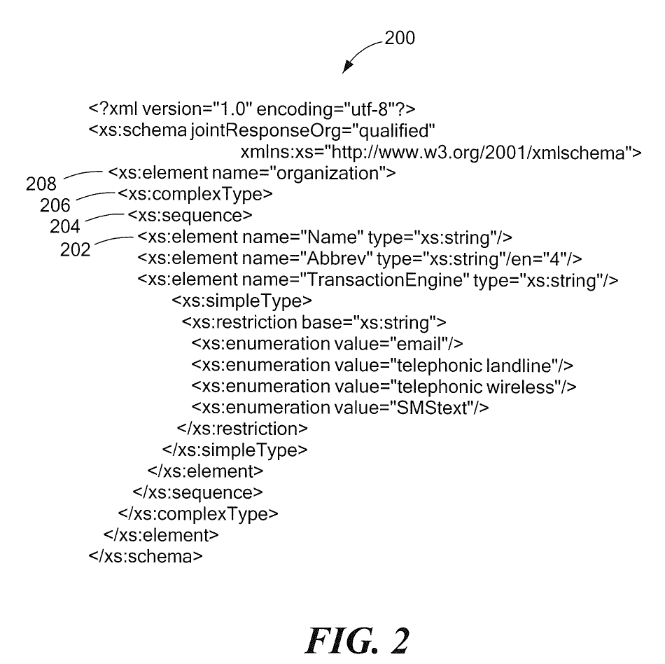

Referring now to FIG. 2, an XML schema 200 defines element names 202, hierarchical relationships 204, data types 206, and constraints 208 in the domains of Emergency Management, Immigration, Infrastructure Protection, Intelligence, International Trade, Justice, and Person Screening.

One approach for organizations needing to exchange information is to use subsets of the existing XML schemas that match the types of information to be exchanged. If none of the existing XML schemas are appropriate, it is possible to define new XML schema.

Referring again to FIG. 1, in one embodiment the information integrator 10 is provided as an AquaLogic Data Services Platform, sold by Oracle Corporation of Redwood Shores, Calif., which can be used to map database fields, information returned from web services, and metadata to NIEM schema elements. This makes the information returned from a user query NIEM complaint, facilitating use by other users and systems.

The information integrator 10 facilitates access and manipulation of information from disparate sources 12a-12n. Physical information stores including, but not limited to, relational databases, web services, XML files, and flat files are modeled as abstract data sources with well-defined XML representations. In a further embodiment, a graphical mapping tool is used to define and transcribe relationships between an abstract data source and an XML representation. By defining multiple physical information stores using the same representation, data from vastly different systems can be handled in a common way.

The information integrator 10 may also act as a query broker, allowing a user to specify queries and filters on groups of abstract data sources. Queries can be built at design time using either a graphical query-building tool or a query language, such as the XQuery language. Queries can also be assembled at run time. The information integrator 10 translates queries on the abstract model to an optimized query on the underlying physical information sources. Combining searches across multiple abstract models is simplified and the underlying query engine determines the most efficient way to construct and executed a query plan.

Referring again to FIG. 1, in one embodiment, the service registry 20 is provided as an AquaLogic Service Registry (also sold by Oracle Corporation) which functions as yellow pages for deployed integration services. The yellow pages registry functions as a Universal Description, Discovery and Integration (UDDI) registry including information needed to locate services and identify the requirements for interacting with the services. The service registry 20 may be integrated with one or more web user interfaces 5a, 5b, 5c so that users can select the information sources 12a-12n and types of data they wish to query.

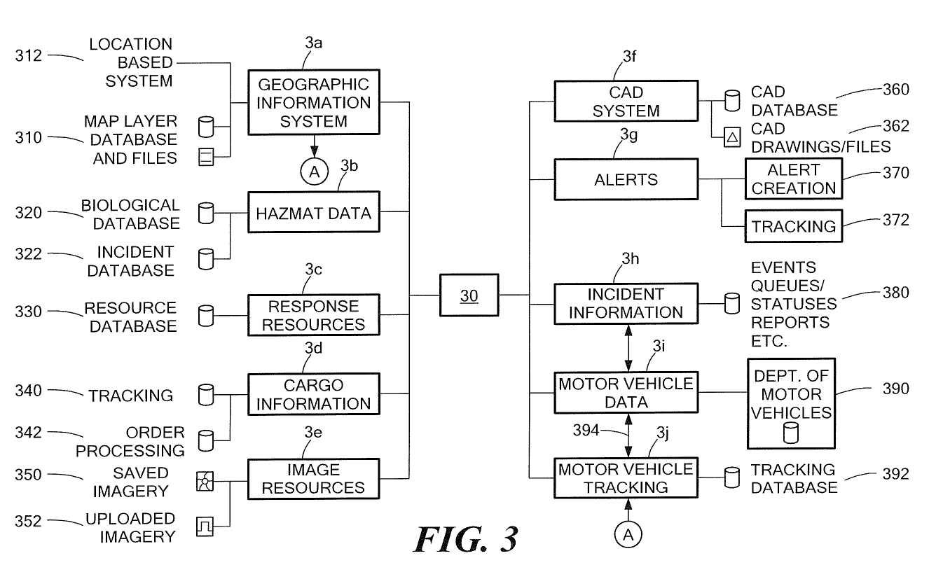

Referring now to FIG. 3, in one exemplary environment incorporating the systems and techniques described herein, a data services platform 30 integrates information sources 3a-3j including: a Geographic Information System (GIS) 3a, Hazmat data 3b, response resources 3c, cargo information 3d, image resources 3e, a Computer Aided Design (CAD) system 3f, alert information 3g, incident information 3h, motor vehicle data 3i, and tracking data 3j. Those of ordinary skill in the art will appreciate, of course, that any number of information sources (fewer or greater than those shown in FIG. 3) may be used. Furthermore, in addition to native content, the systems and techniques provide users with source attributes for all the information they receive from these sources.

The GIS 3a may include map layer data 310 including both vector and raster information that provides spatial coordinates for natural features, transportation routes, built infrastructure, and locations of hospitals, schools, etc. For example, the vector data may include roads, transmission networks, as well as other infrastructure, and raster data may include satellite imagery, street views, as well as other pixilated information. The GIS may also include a location-based system 312 for tracking information such as vehicle position. The location-based system 312 may use a geographic positioning system and assisted wireless tracking for support.

The hazmat data 3b may include material characteristics, hazards zones, control zones, decontamination measures, protective action distances, etc. The hazmat data 3b may be supported by a biological database 320 and an incident database 322 and may include characteristics of a biological agent released during a terrorist attack, geographic zones of contamination (such as latitude longitude coordinates, exposed city blocks, and buildings) of the biological agent, as well as controlled areas.

The response resources 3c include logistical information about resources that may need to be applied to an incident. The logical information may be stored in a resource database 330. Examples are the number of patients a hospital can handle, available ambulances, available fire department resources and their status, the number of security resources and their capabilities, etc.

Cargo information 3d includes information on products being shipped by truck such as shipper, material description, emergency response number, consignee, etc. Cargo information 3d may be supported by a tracking database 340 and an order processing system 342.

Image resources 3e include pictures taken from aerial platforms, sensor cameras, and on-scene cell phone cameras. Such image information may include prior saved imagery 350 or uploaded imagery 352 in response to the incident.

The CAD system 3f includes drawings such as floor plans, evacuation routes, and utility information (power transmission, gas, water, sewer etc.) for structures in an area of interest. The CAD system 3f may include a CAD database 360 and CAD drawing files 362.

Alert information 3g includes formatted messages that have a classification, concern a certain area and/or time, concern a subject, and have an address list. Alert information 3g may include components for alert creation 370 and tracking 372.

Incident information 3h is the running narrative about the incident and can include such things as events, times, status, reports, assessments, and assignments. The incident information may be saved in a database 380.

Motor vehicle data 3i includes motor vehicle registry information such as vehicle make, model, owner, plate number, etc. The data may be obtained from departments of motor vehicles 390 of various states.

Motor vehicle tracking 3j includes geographic coordinates and attribute information for objects of interest, which may be stored in a tracking database 392. Furthermore, motor vehicle tracking may be supported by the GIS 3a, as represented by symbol A. The motor vehicle tracking 3j may be coupled 394 to the motor vehicle data 3i to support vehicle attribute and position information sharing.

The systems and techniques described herein integrate information from a variety of sources, such as databases, computer files, and/or services interfaces. TABLE 1 below shows the allocation of planned information sources to source types.

TABLE 1
Information Sources and Formats

| | Database | | |
|---|---|---|---|
| | Tables | Files | Services |
| Geographic | X | X | |
| Information System | | | |
| Hazmat data | X | | |
| Response | X | | |
| Resources | | | |
| Cargo Information | X | | |
| Image resources | | X | |
| CAD system | X | X | |
| Alert Information | | | X |
| Incident Information | X | | X |
| Motor Vehicle Data | X | | |
| Motor Vehicle | X | | X |
| Tracking | | | |

Semantic models will now be described in more detail. Semantic models, or ontologies, are used to create knowledge bases about information important to the incident domains, such as border security response and emergency response domains. These semantic models contain concepts, relationships between concepts, and properties relevant to the Communities of Interest (COI) within the incident domain. In some instances, the semantic models may encapsulate multiple domains, such as a border security domain and an emergency response domain. The semantic models may share concepts and relationships, such as common organizational entities, or may be jointly coordinated by a high-level organization in a hierarchical semantic model.

In one embodiment, the semantic models may be represented in XML format using W3C standards known in the art such as Web Ontology Language (OWL) and the Resources Description Framework (RDF). Such languages are rigorous enough to support inferencing engines and may be queried through other W3C standards such as SPARQL Protocol and RDF Query Language.

In one embodiment, the semantic model enables users to query combined data sources for information and then attach the results to appropriate concepts in the semantic model through user interface functionality. In this way, users can build a personalized incident-related knowledge base that can be shared with other users, or combined with those of other users to form an aggregate incident knowledge base.

In another embodiment, the semantic model assists users in formulating queries to get information they need. For example, an application logic processor similar to that described in conjunction with FIG. 1 may present familiar domain concepts and relationships as selectable items in the user interface. For example, users can select data sources, select query parameters, and enter query information.

In one embodiment, an information integrator similar to that described in conjunction with the system of FIG. 1 enables administrators to quickly add new sources of information. In one exemplary embodiment, the system will be preloaded with many different information sources to handle homeland security and emergency management scenarios and administrators can select various information sources based on their needs.

Integrating a new information source of an existing type can be done via an interface to a registry processor similar to that described in conjunction with FIG. 1. A user with appropriate permissions can log in, and choose an information source type (hospitals, for instance). The user will then be presented with some fields that need to be filled in with information about the source type (such as location of the hospital, if it has an emergency room, etc.) to be used for source discovery. Then the user may define a connection to the information source so that the registry processor can locate the information source. After this is completed, the user can then search the new information source in a data query.

If the existing information source types are insufficient for an information source, an information integrator similar to that described in conjunction with FIG. 1 can be extended for the information source type. For example, an administrator who has an understanding of XML can design a new NIEM schema document to represent the information source type.

Referring again to FIG. 1, in a further embodiment, the system 100 includes an information merger that merges the new NIEM schema document into the information integrator 10. A decision must then be made (e.g. by the administrator) as to what metadata needs to be specified for the merged information source type. After this is completed, the information integrator 10 can accept information sources of the merged type via the previously described method.

The systems and techniques for incident management described herein rely on a loosely-coupled architecture containing components with standards-based interfaces. The components include hardware components, software components, or a combination thereof. The standards-based interfaces facilitate obtaining information from externals systems that might be needed to mitigate an adverse outcome of an incident. The standards-based interfaces facilitate the use of the services described herein by other systems. Advantageously, such openness facilitates information flow from an incident site to higher coordination levels. Information can flow from decision makers to people on the scene, for example, rescue workers, law enforcement officials, and medical teams.

As described above, the systems and techniques include semantic models including terms and relationships that are relevant to the tasks joint responders have to perform in an incident response environment to help them obtain information they need. In this way, the semantic model provides knowledgeable guidance and assists joint responders in formulating more precise queries to reduce unwanted information or clutter, and increase the likelihood of obtaining desirable, necessary, and essential information.

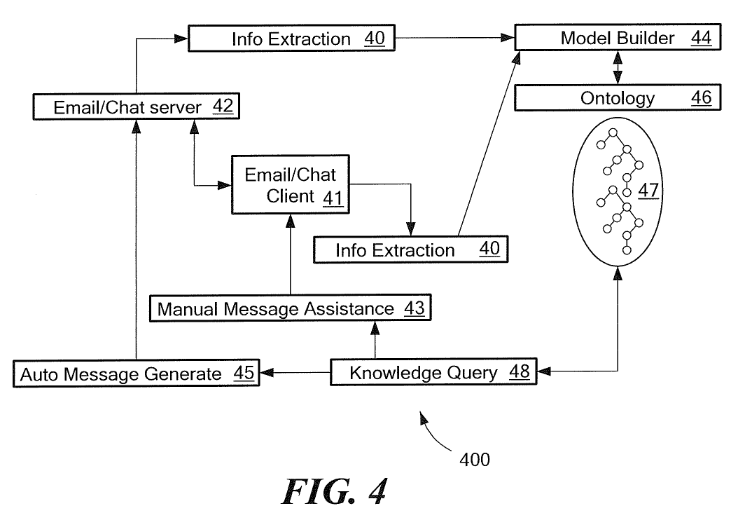

Referring now to FIG. 4, a system 400 includes an information extraction component 40 which parses and extracts information from chat or email messages between electronic mail clients 41 and servers 42. Information that is extracted can include, but is not limited to, the information sender, the information receiver, the information subject (for example, the subject of an email or a chat), content category, sender and receiver locations, and message date or timestamp. The extracted information is passed to a model builder component 44.

An ontology component 46 is an incident information storage mechanism about organizations, organizational relationships, joint responders, and the organizations to which joint responders belong or have been assigned to as well as other information.

The model builder component 44 adds, modifies, or deletes concept and instance information within the ontology component 46. The model builder component 44 takes the information items it receives and composes them into an XML fragment that can be appended to a knowledge representation ontology model 47. In one embodiment, the knowledge representation ontology model 47 is represented in the web ontology language description logic (OWL-DL) format.

A knowledge query component 48 helps users formulate queries of the information maintained by the model builder component 44. User inputs may be translated into SPARQL and executed against the ontology model 47.

In a further embodiment, a manual message assistance component 43 provides information to a user which can be imported into a message, for example, by cutting and pasting the information into the message and/or dragging and dropping the information into the message.

In another embodiment, an auto generate message component 45 takes message content provided by a user, adds the necessary header information based on query results from the knowledge query component 48, and then sends message information to an email/chat server 42 for distribution to targeted recipients via an email/chat client 41.

In use, an application administrator may add organizations and relationships to the ontology model 46 through an application user interface (not shown) in communication with the model builder component 44. Individual responder information such as name, identification, location, and organization may also be added by the administrator.

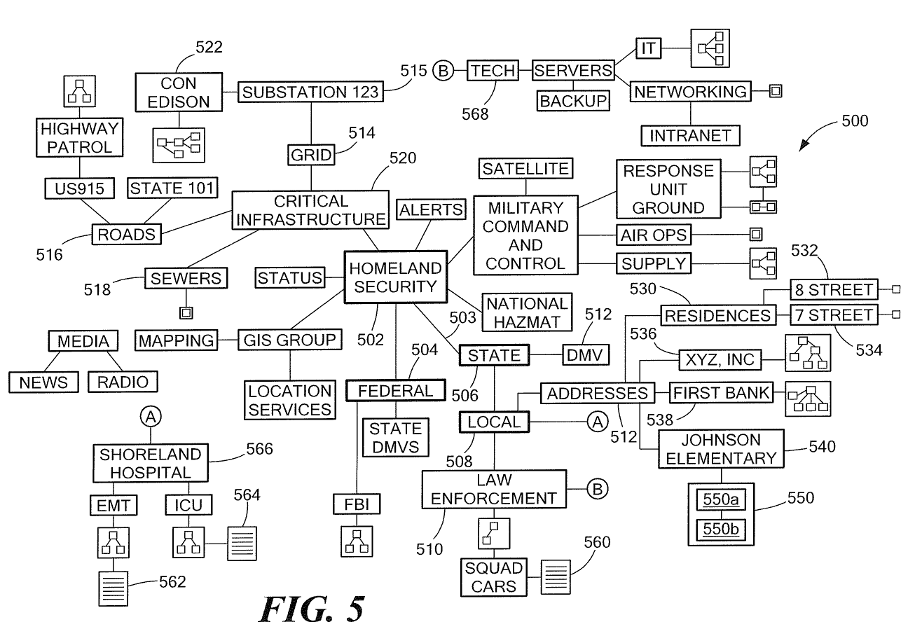

Referring now to FIG. 5, an exemplary ontology 500 of the type for use with the inventive systems and techniques includes organizational relationship information (such as organization X reports to organization Y) and joint responder information. Such information can be based on policies and plans and can be provided by participating organizations or using an on-scene command function. Further, this information may be used to create a general organizational model and populate it with specific instance information.

The exemplary ontology of FIG. 5 includes nodes (e.g., node 502) which represent organizations and links (e.g. link 503) which represent relationships between organizations. For example, the Department of Homeland Security 502, which may include one or more entities, is directly linked to federal organizations 504 and state organizations 506 for event response. State organizations 506 may be further linked to local organization 508.

Still other nodes (e.g., node 520) represent functional aspects of the ontology 500. For example, critical infrastructure 520 includes the electric grid 514, roads 516, and sewers 518. The electric grid 514 may be subdivided into substations which service portions of the electric grid, an example of which is Substation 123 (designated by reference numeral 515), and linked to power provider Con Edison 522.

One or more other organizations at the local level are shown in FIG. 5, including local law enforcement 510 and local addresses 512, which is parent node to link local addresses affected by an event. For example, an event may be localized to a suburban block including residences 530 (such as X Street residence 532 and Y Street residence 534), XYZ, Inc. 536, First Bank 538, and Johnson Elementary School 540.

Johnson Elementary School 540 may include a group of individuals and/or departments 550 with management roles in responding to an event. The group 550 may include the school's principal 550a and vice-principal 550b who are responsible for contacting parents and have respective primary and secondary school management roles. Although these groups and departments may not be under the direct control of the Department of Homeland Security or the organizations further up in the ontology 500, it is important that messages be broadcast to these departments so that desired, necessary, or essential information can be obtained for event response.

For example, the Department of Homeland Security may broadcast a message that a van last spotted in the area may be carrying a biological toxin. The message may be distributed to organizations and joint responders on a need-to-know basis identified in the ontology 500, for example, to local organizations such as Johnson Elementary School 540. Joint responders at Johnson Elementary School 540 after receiving the message may be on the look out for the van, and if they spot it, can send a message to organizations identified in the ontology 500. For example, the vice-principal 550b may spot the van and compose an electronic mail that gets distributed to other organizations linked in the ontology to the school, including local law enforcement.

Other portions of the ontology 500 may include organizational assets that may be needed for event response, such as squad cars 560 or emergency response vehicles 562 and intensive care units 564 of Shoreland Hospital 566, a local hospital. Organization assets may also represent assets that are vulnerable to an event.

Portions of the ontology 500 may be separated from the main model for ease of illustration. For example, portion 570 at A, and portion 572 at B represent respective Shoreland Hospital 566 (and its organizational structure) and technology infrastructure 568, as may be important in events involving acts of cyber-terrorism and sabotage.

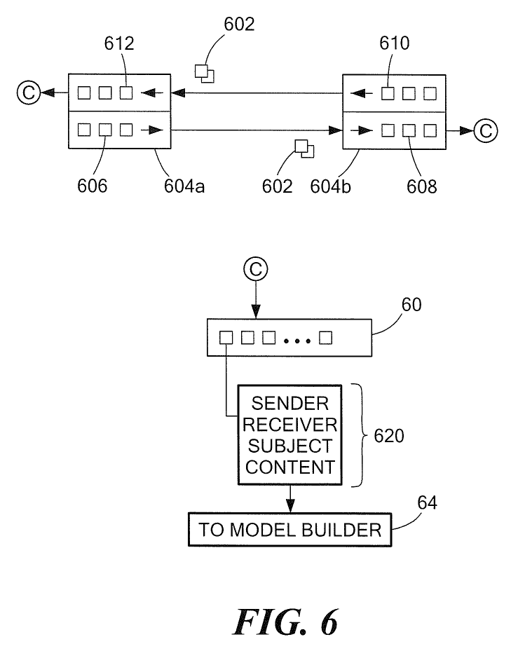

Referring now to FIG. 6, in one embodiment of the inventive systems and techniques, an information extractor 60 extracts information from messages 602 such as electronic mails and/or instant messages to joint responders of an incident. For example, the messages 602 may be composed by users on an electronic mail client and transmitted to other users over electronic mail servers 604a, 604b. Other appropriate messaging techniques may be used such as voice mail and text messaging.

A first joint responder may compose messages 606 and send it to a second joint responder who receives the message 608. Still further, the second joint responder may compose messages 610 and send it to the first joint responder who receives the message 612.

The information extractor 60 may extract information from one, some, or all of the messages. For example, as designed by C in FIG. 6, the information extractor 60 may extract information from received messages 608, 612. Information extracted 620 may include, but is not limited to, message sender information, message receiver information, the message subject, and message content.

A model builder 64 uses the extracted information 620 to build (i.e. add and make available) and characterize links between organizations and individuals within a semantic model. The model builder 64 may use subject matter of the messages and various statistical attributes, such as the number of messages between individuals, to help characterize the links.

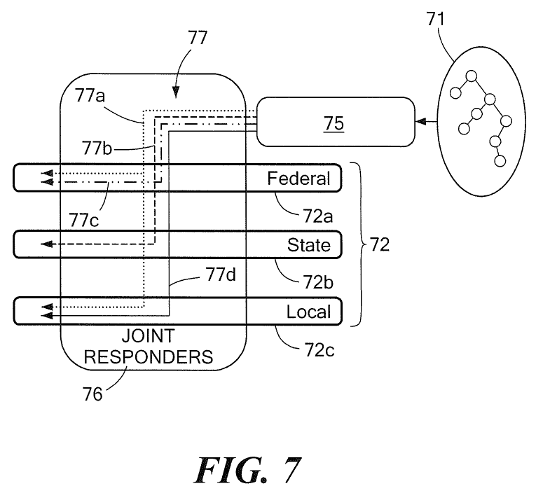

Referring now to FIG. 7, in a further embodiment of the inventive systems and techniques, information may be queried and/or automatically routed to appropriate joint responders within an organization. An auto-message generator 75 uses a semantic model 71 to distribute messages 77 to the appropriate organizations 72 and joint responders 76 within the organizations 72. For example, if information about potential biological toxins that have just been discovered needs to be distributed, the auto-message generator 75 can produce a list of organizations and individuals who have been communicating about biological agents and produce messages to send to those individuals.

In one example embodiment, the auto-message generator 75 distributes a first message 77a to joint responders 76 at the federal level 72a and the local level 72c and a second message 77b to joint responders 76 at the state level 72b. Still further, other messages may be generated and distributed. For example, the auto-message generator 75 may distribute a third message 77c to joint responders 76 at the federal level 72a and a fourth message 77d to joint responders 76 at the local level 72c.

In another embodiment, a user manually distributes information using a knowledge query component to query the semantic model to obtain organizations and individuals for message distribution. The individuals may then be added to an electronic mail distribution list.

In still a further embodiment, the auto-message generator creates a distribution list which includes organization names and electronic mail addresses/chat names for message distribution. Still further, a user can use the knowledge query component to generate distribution lists.

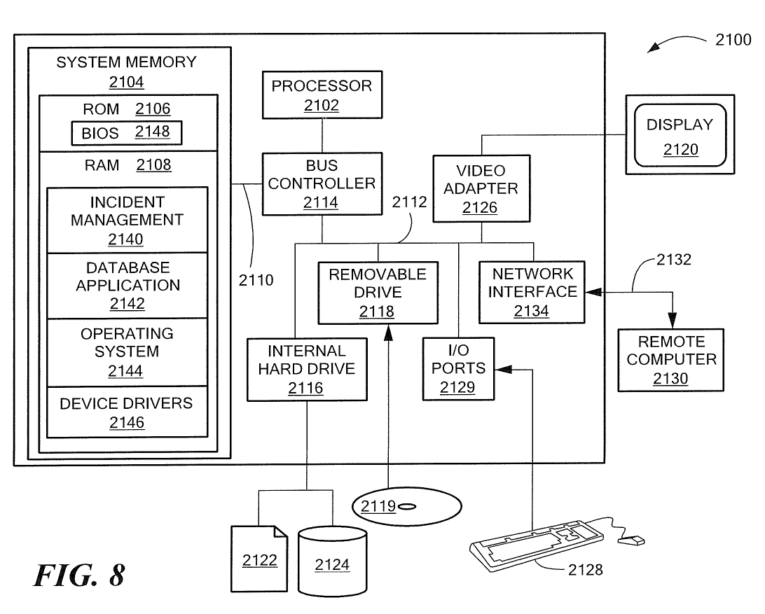

FIG. 8 illustrates a computer 2100 suitable for supporting the operation of an embodiment of the inventive systems and techniques described herein. The computer 2100 includes a processor 2102, for example, a dual-core processor, such as the AMD Athlon™ X2 Dual Core processor from the Advanced Micro Devices Corporation. However, it should be understood that the computer 2100 may use other microprocessors. Computer 2100 can represent any server, personal computer, laptop, or even a battery-powered mobile device such as a hand-held personal computer, personal digital assistant, or smart phone.

Computer 2100 includes a system memory 2104 which is connected to the processor 2102 by a system data/address bus 2110. System memory 2104 includes a read-only memory (ROM) 2106 and random access memory (RAM) 2108. The ROM 2106 represents any device that is primarily read-only including electrically erasable programmable read-only memory (EEPROM), flash memory, etc. RAM 2108 represents any random access memory such as Synchronous Dynamic Random Access Memory (SDRAM). The Basic Input/Output System (BIOS) 2148 for the computer 2100 is stored in ROM 2106 and loaded into RAM 2108 upon booting.

Within the computer 2100, input/output (I/O) bus 2112 is connected to the data/address bus 2110 via a bus controller 2114. In one embodiment, the i/O bus 2112 is implemented as a Peripheral Component Interconnect (PCI) bus. The bus controller 2114 examines all signals from the processor 2102 to route signals to the appropriate bus. Signals between processor 2102 and the system memory 2104 are passed through the bus controller 2114. However, signals from the processor 2102 intended for devices other than system memory 2104 are routed to the I/O bus 2112.

Various devices are connected to the I/O bus 2112 including internal hard drive 2116 and removable storage drive 2118 such as a CD-ROM drive used to read a compact disk 2119 or a floppy drive used to read a floppy disk. The internal hard drive 2116 is used to store data, such as in files 2122 and database 2124. Database 2124 includes a structured collection of data, such as a relational database. A display 2120, such as a cathode ray tube (CRT), liquid-crystal display (LCD), etc. is connected to the I/O bus 2112 via a video adapter 2126.

A user enters commands and information into the computer 2100 by using input devices 2128, such as a keyboard and a mouse, which are connected to I/O bus 2112 via I/O ports 2129. Other types of pointing devices that may be used include track balls, joy sticks, and tracking devices suitable for positioning a cursor on a display screen of the display 2120.

Computer 2100 may include a network interface 2134 to connect to a remote computer 2130, an intranet, or the Internet via network 2132. The network 2132 may be a local area network or any other suitable communications network.

Computer-readable modules and applications 2140 and other data are typically stored on memory storage devices, which may include the internal hard drive 2116 or the compact disk 2119, and are copied to the RAM 2108 from the memory storage devices. In one embodiment, computer-readable modules and applications 2140 are stored in ROM 2106 and copied to RAM 2108 for execution, or are directly executed from ROM 2106. In still another embodiment, the computer-readable modules and applications 2140 are stored on external storage devices, for example, a hard drive of an external server computer, and delivered electronically from the external storage devices via network 2132.

The computer-readable modules 2140 may include compiled instructions for implementing an incident management system similar to that described in conjunction with the figures. Messages to joint responders, for example, may be outputted to display 2120 to enable joint responders to receive incident information that is desired, needed, or essential and to minimize clutter and overhead from unwanted, unneeded, or non-essential messages. The results of the incident management system may be outputted to external systems, such as those used by field personnel to aide on-the-scene response.

Components of the incident response system may be implemented in one or more of the computer-readable modules. For example, an information integrator, application logic processor, and registry processor similar to those described in conjunction with FIG. 1 may be implemented in separate computer-readable modules. Still further, a user interface portlet may be implemented in a computer-readable module and rendered as user interface objects to display 2120.

Still further, a semantic model builder, information extractor, and message generators for incident management similar to those described in conjunction with FIG. 4 may be implemented in separate computer-readable modules, or a combination thereof.

In a further embodiment, the computer 2100 may execute an incident management system on separate processors to increase response time and for fault tolerance. For example, an information integrator may be executed on a first processor and a application logic processor may be executed on a second processor. The first and second processor may be respective processors of a dual-core processor.

Alternatively, the first and second processor may respective first and second computing devices.

The computer 2100 may execute a database application 2142, such as Oracle™ database from Oracle Corporation, to model, organize, and query data stored in database 2124. The data may be used by the computer-readable modules and applications 2140 and/or passed over the network 2132 to the remote computer 2130 and other systems.

In general, the operating system 2144 executes computer-readable modules and applications 2140 and carries out instructions issued by the user. For example, when the user wants to execute a computer-readable module 2140, the operating system 2144 interprets the instruction and causes the processor 2102 to load the computer-readable module 2140 into RAM 2108 from memory storage devices. Once the computer-readable module 2140 is loaded into RAM 2108, the processor 2102 can use the computer-readable module 2140 to carry out various instructions. The processor 2102 may also load portions of computer-readable modules and applications 2140 into RAM 2108 as needed. The operating system 2144 uses device drivers 2146 to interface with various devices, including memory storage devices, such as hard drive 2116 and removable storage drive 2118, network interface 2134, I/O ports 2129, video adapter 2126, and printers.

Having described preferred embodiments of the invention it will now become apparent to those of ordinary skill in the art that other embodiments incorporating these concepts may be used. Accordingly, it is submitted that the invention should not be limited to the described embodiments but rather should be limited only by the spirit and scope of the appended claims.

1. An incident management system comprising:
a plurality of information sources, each of the information sources configured to collect information for use by a plurality of joint-responders in an incident management process;
an information integrator configured to receive and store information from each of the information sources;
at least one semantic model coupled to the information integrator, the semantic model including a plurality of relationships associated with the plurality of joint-responders;
an application logic processor which utilizes the at least one semantic model to determine which of a plurality of joint-responder organizations should receive information from the information integrator; and
a registry processor coupled to the information integrator to help at least some of the plurality of joint-responders connect to desired information within at least a portion of the plurality of information sources.

2. The system of claim 1 further comprising a portlet coupled to the application logic processor through the at least one semantic model, the portlet having controls for users to select data sources, select query parameters, and enter query information.

3. A method of incident management comprising:
collecting information for a plurality of information sources for use by a plurality of joint-responders;
in an information integrator, receiving and storing information from each of the plurality of information sources;
coupling at least one semantic model to the information integrator, the at least one semantic model including a plurality of relationships associated with the plurality of joint-responders;
in an application logic processor, utilizing the at least one semantic model to determine which of a plurality of joint-responder organizations should receive information; and
using a registry processor coupled to the information integrator to connect at least some of the plurality of joint-responders to desired information within at least a portion of the plurality of information sources.

4. The method of claim 3 further comprising:
providing a portlet coupled to the application logic processor through the at least one semantic model, the portlet having controls for users to select data sources, select query parameters, and enter query information.

5. An incident management system comprising:
a model builder configured to build at least one semantic model comprising a plurality of relationships between involved organizations, each of the involved organizations associated with at least one of a plurality of involved parties;
an information extractor configured to capture at least one communication sent by one of the involved parties and received by at least one other of the involved parties and to send communications information to the model builder; and
an information integrator configured to distribute a subject communication from an involved party sender to at least one involved party receiver based upon at least one of the plurality of relationships of the at least one semantic model.

6. The system of claim 5, wherein the communications information includes a communications topic, a communications sender, and at least one communications receiver and the communications information is used by the model builder to define at least one of the plurality of relationships between involved organizations.

7. A method of incident management comprising:
in a model builder, building at least one semantic model comprising a plurality of relationships between involved organizations, each of the involved organizations associated with at least one of a plurality of involved parties;
in an information extractor, capturing at least one communication sent by one of the involved parties and received by at least one other of the involved parties and sending the communications information to the model builder; and
in an information integrator, distributing a subject communication from an involved party sender to at least one involved party receiver based upon the at least one semantic model.

8. The method of claim 7, wherein the communications information includes a communications topic, a communications sender, and at least one communications receiver and further comprising:
defining at least one of the plurality of relationships between involved organizations using the communications information.
